(19) United States
(12) Patent Application Publication
(10) Pub. No.: US 2002/0165693 A1
(43) Pub. Date: Nov. 7, 2002

(54) Procedure and arrangement for controlling and optimizing a process

(76) Inventor: Marko Kesti, Oulu (FI)

Correspondence Address: Hoffmann & Baron, LLP, 6900 Jericho Turnpike, Syosset, NY, 11791, US

(21) Appl. No.: 10/091,762

(22) Filed: Mar. 5, 2002

(30) Foreign Application Priority Data
Apr. 24, 2001 (FI) 20010838

(51) Int. Cl. G06F 17/18

(52) U.S. Cl. 702/181

(57) ABSTRACT

The invention relates to a procedure and arrangement for controlling and optimizing a process. In the procedure at least two different types of initial information is collected and a comparative value, which is compared to a scale, is created based on the collected initial information, and a process is controlled based on the comparative value to attain optimized result. The procedure is used, for example, to measure commitment and competence of personnel to calculate probability for attaining a set goal.

The present invention relates to a procedure as defined in the preamble of claim 1 and an arrangement defined in the preamble of claim 8 for controlling and optimizing a process.

Procedure and arrangement in accordance with the invention, which in the following are called by the common name solution, can be used for many purposes for controlling and optimizing different processes in industrial environments, in business life, and in other suitable connections. Various initial information based on pre-determined criteria is collected with the help of the solution and a probability for means of achieving a final result of the followed process is created based on the collected initial information. The referred processes, used in the industry, are for instance measuring and optimizing the working capacity and commitment of used personnel, measuring and lengthening the life-span of products, measuring and improving customer satisfaction, continuous development of supplier competence, improving the quality of products and following and optimizing manufacturing processes.

The tightening competition in the industry has given rise to an increasing need to measure and control factors contributing to continuous improvement. Measuring and improving the material values in optimizing the functions of companies is not enough anymore, the part of the mental values has risen to be a very important factor of the competitive ability of a company. This means that measuring and developing the health, work ability, commitment and other resources of the personnel have become very important for companies. These days this kind of activity is thus to be regarded as a very much industrially applicable procedure for maintaining and improving the competitive ability of companies.

Because human resources in companies have risen to great importance, the resources have been measured in the industry using different means. The personnel have mainly been asked different series of questions and an expert has then evaluated each person's capability for different duties. These types of tests have often been conducted for example at employment interviews. The disadvantage with these procedures is that assistance of an independent expert is needed for as well to perform the test as to evaluate the results of the test. Furthermore, the tested person is often not informed about the results and cannot thus make use of them. Another disadvantage has been that results obtained by this type of tests cannot be connected to attaining the goals set by companies. The same problems apply for conducted customer satisfaction evaluations as well as buyer and supplier evaluations.

A solution for testing personal characteristics of human beings is presented in WO-publication nr. WO 01/06929. A solution in accordance with the WO-publication enables personal development originating from a person himself, without the assistance of an independent expert. In this system the ability of a person is in a way a separate element and the arrangement functions mainly as a tool for personal development. The disadvantage in the solution in accordance with the publication is just that it relates to an indicator of personal ability, where the person's opinion or commitment is trapped inside the ability measurement so that the results cannot be directed to attaining the goals and issues set by company management.

U.S. Pat. No. 6,008,817 presents a comparative evaluating arrangement for facilitating decision making. Sum of vectors is used in the patent, and the angle of the vectors is defined with the help of a tangent so that a vector can also get a negative value. This arrangement is suitable for comparative evaluation, but the disadvantage with the arrangement is that probability calculation cannot be used, because then the value of the vector would have to be between 0 . . . 1, when 0 is equivalent to the qualifier “not attainable” and 1 is equivalent to the qualifier “attainable”.

Furthermore, different procedures are used to measure human resources of the personnel, such as personnel account, work ability index and work and well-being barometer. Patent publications JP7116286, SU1445687 and SU876110 are also concentrated on measuring a person's work ability and publication WO 00/26841 is mainly concentrated on foretelling cognitive behavior. A common disadvantage with these procedures and with the arrangement relating to the above-presented U.S. Pat. No. 6,008,817 is that these procedures do not however direct management practice, because the resources have not been connected to business goals. Furthermore, these procedures indicate neither the available human competence nor what impact this has on the probability of attaining the goals.

The object of the solution in accordance with the present invention is to eliminate aforesaid disadvantages and to achieve a profitable and reliable procedure and arrangement for controlling and optimizing a process with the help of probability to attain set goals. The procedure of the invention is characterized by what is presented in the characterizing part of claim 1. Correspondingly, the arrangement of the invention is characterized by what is presented in the characterizing part of claim 8. The other forms of application of the invention are characterized by what is presented in other claims.

The solution of the invention provides the advantage that a reliable procedure and arrangement tool is achieved for measuring different procedures, such as human competence, in relation to set goals and continuous interaction for optimizing the probability for attaining goals. Competence in this connection refers to the work ability of a person, work team or such, in other words, resources combined with commitment to attain a given goal. With the help of the solution of the invention a company can set goals that are in balance with the human competence of the team realizing those goals. With the help of the tool provided by the solution of the invention the management of a company can in cooperation with personnel resources develop its activities towards the desired direction. The personnel can be brought to commit to the goals and the management is informed of the probability for the realization and the possible changes in the competence in time to consider reparative actions.

The present invention provides also the advantage that the solution of the invention is well adapted for several other uses than those mentioned in the previous paragraph. Alternating pre-determined criteria, for example questions from different subject area or input-data taken from a process, and changing target groups and scales the invention can be used in connection with for example improving sales of an above-mentioned product by means of evaluation of customer relations and development needs, continuous improvement of supplier competence, evaluation and influencing the extending of the life-span of a product and also improving characteristics relating directly to different products by means of user surveys. Furthermore the solution in accordance with the invention can be used to monitor industrial processes by measuring the process and calculating probabilities for desired or non-desired events in the process on basis of the measured results.

Another advantage of the solution in accordance with the invention is that the solution provides that a clear overall view can be brought out to form a base for the decision-making of the entire management of a company. The competence of a company in relation to its goals can be presented clearly and reliably also to the owners. Furthermore, it is possible to examine different levels of the organization ranging from the whole company all the way to an employee, which provides that, for example, probability of the realization of a desired change can be predicted and possible difficulties in carrying out the change can be avoided. A further advantage is that appropriate rewarding goals can easily be set for responsible persons on different levels. The scale in accordance with the invention is such a readable form of transferring information that all necessary information can be transferred as one graphic figure to the WAP-device or corresponding remote device of a responsible person. Another advantage is that alarm boundaries for automatic alarms can be installed in the arrangement.

In the following, the invention will be described in detail by the aid of an embodiment example with reference to the attached drawings, wherein

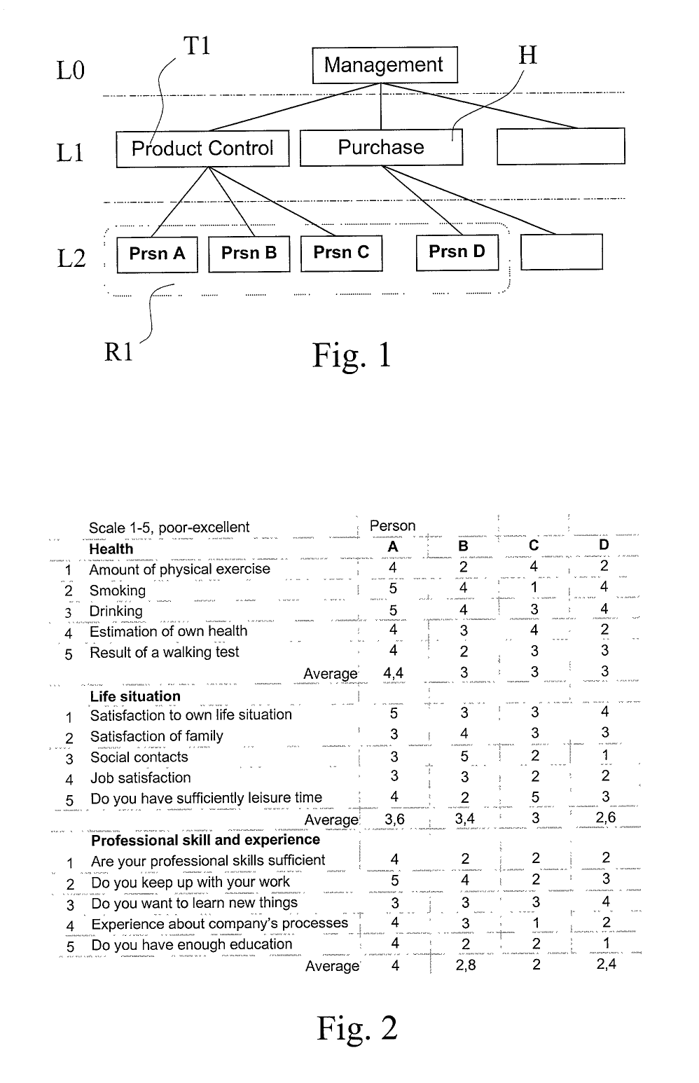

FIG. 1 presents a simplified organization scheme of a company applying the invention,

FIG. 2 presents an example for a series of questions that is used to measure resources of the personnel, in other words potential,

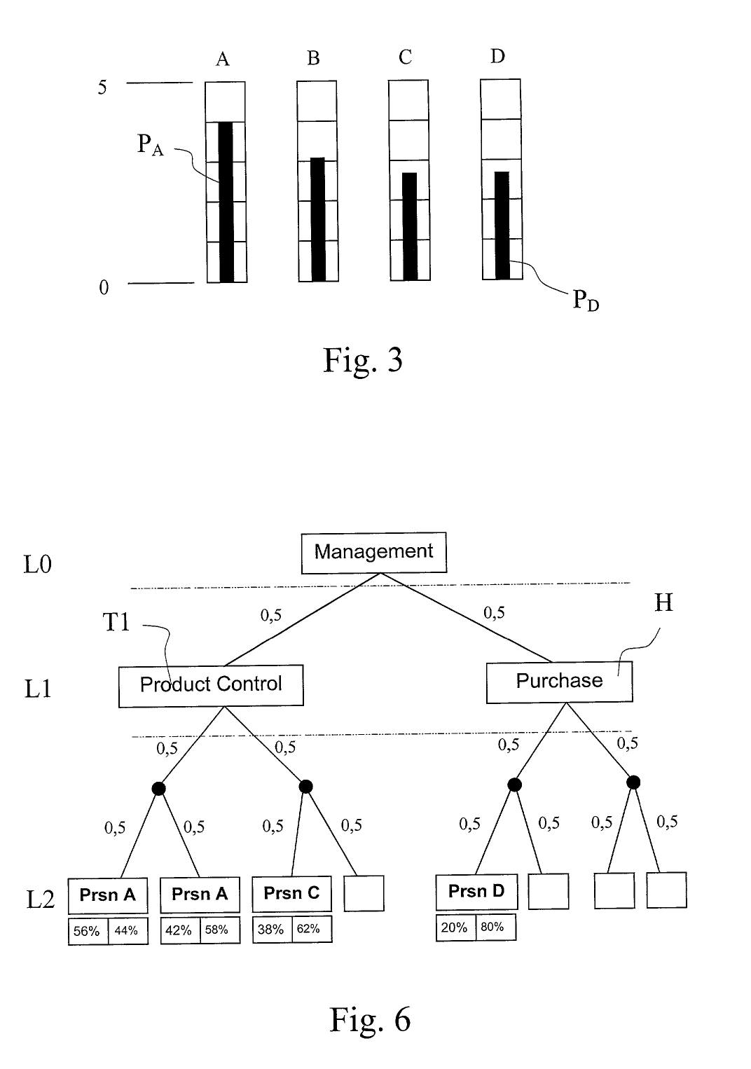

FIG. 3 presents as an example indexing the potential of the personnel,

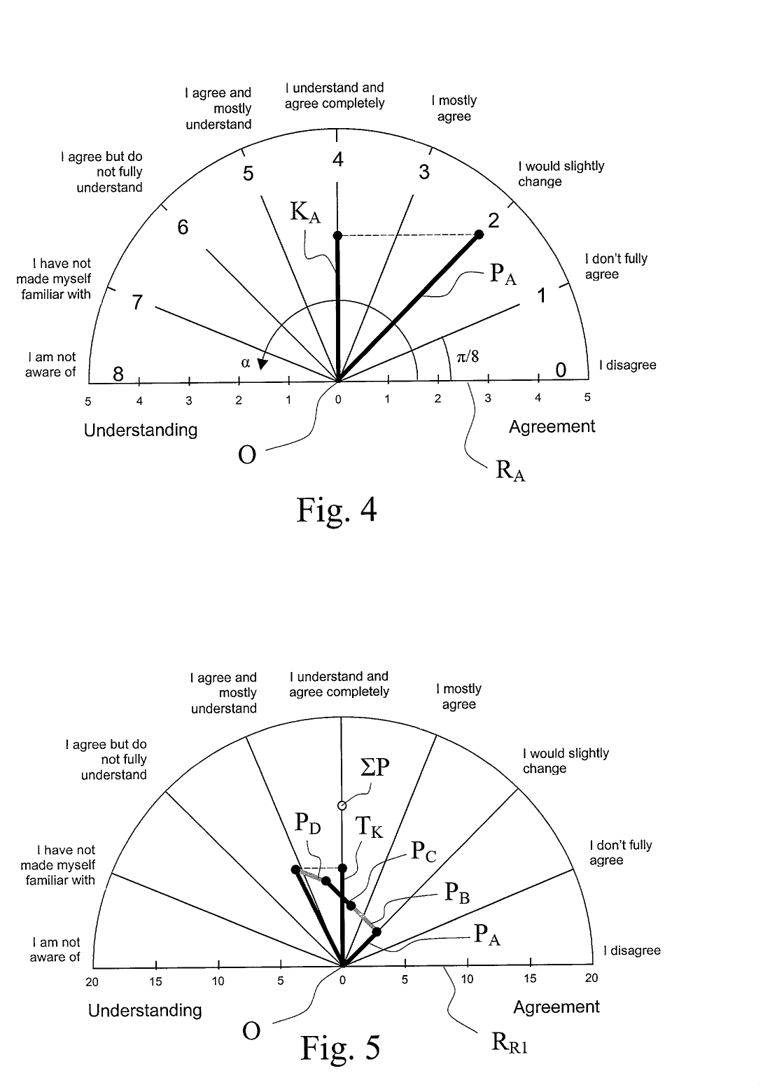

FIG. 4 presents the defining of a person's competence of the measured potential,

FIG. 5 presents an example of measuring the competence of an entire group,

FIG. 6 presents a correlation to statistical tree pattern,

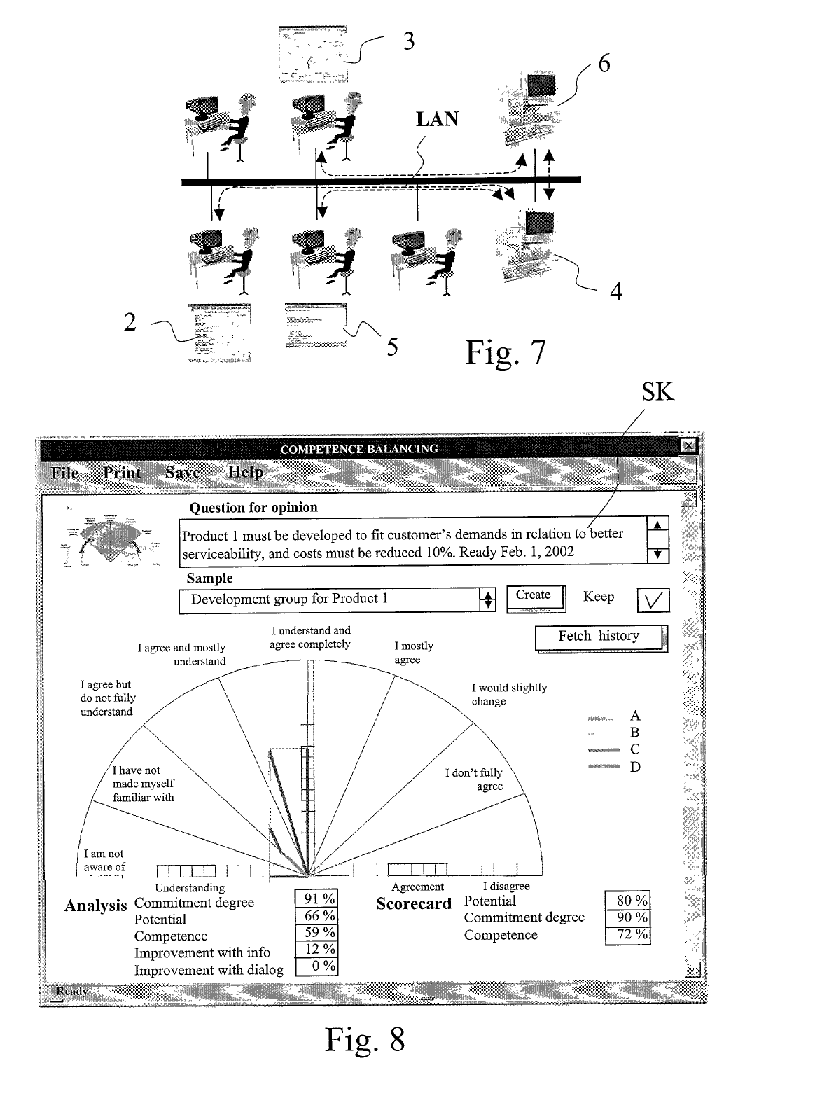

FIG. 7 presents an arrangement tool in accordance with the invention for measuring commitment and competence,

FIG. 8 presents the competence of an exemplary group after committing actions,

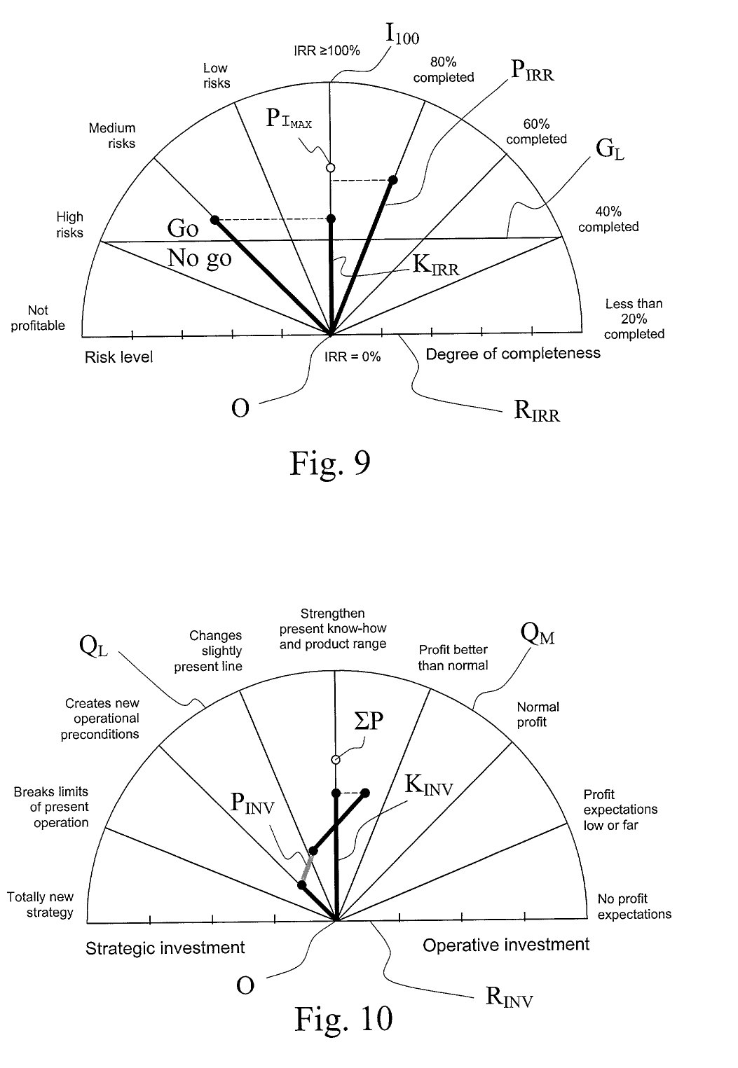

FIG. 9 presents use of a solution in accordance with the invention to facilitate go-no go- decision-making and

FIG. 10 presents use of solution in accordance the invention in analyzing development investments and similar strategic processes.

In the following the function of the procedure and arrangement tool according to the invention, when the target is the balancing of the competence of the personnel to the set goal, will be described.

The example describes a group R1, which is responsible for developing a product Q to be competitive according to goal definitions set by the management. The example group R1 consists, according to the organization scheme, of persons A, B, C and D. Persons A, B, C are from product control unit T1 and person D is from purchasing department H.

The management has set the following goal: Product Q has to be developed to correspond to changed customer demands and, in addition, product costs have to be reduced by 10%. The development work has to be done within the current year.

The work ability of the personnel can also be called the resources of the personnel, which in connection with the present invention is further called potential. Measuring the work ability of the personnel is done using a potential user interface 2 in accordance with the invention especially suitable for this purpose, presented in connection with the arrangement description in FIG. 7. With the aid of the user interface 2 the persons answer an inquiry, an example of which is presented in FIG. 2. The potential is measured for example, by series of questions from three different subject areas, the subject area being, for example, health, life situation and professional skill and experience. Part of the questions are answered by the person himself based on his own evaluation on a scale 1 . . . 5, which corresponds to verbal evaluation poor . . . excellent. Correspondingly, an input value for part of the questions is obtained as a result of a test, such as a walking test. An average of the answers from the different subject areas is calculated and further a total average of the averages of the different subject areas is calculated, which total average presents a person's potential P. The results of the answers to the potential inquiry of all persons in group R1 and the averages of the different subject areas are illustrated in the listing presented in FIG. 2.

Personal potential P calculated as a result of the inquiry is indexed according to the principle in FIG. 3 to a scale, for which index the maximum value Iₘₐₓ is chosen to be the digit 5 in accordance with the maximum value 5 in the potential inquiry. Personal potential of each of the persons who answered the inquiry is illustrated as a segment of a line P, in which P_{A} indicates the potential of person A of the group etc. The potential P_{A} of person A is thus, at the time of the inquiry, 4. Correspondingly, the potential P_{D} of person D is, at the time of the inquiry, 2,7. Each person's personal potential P is saved in the database 4 included in the arrangement, which can be any known database that supports, among other things, ASP-technology. In later measurements the personal potential can change because of a change in one of the contributory factors. The database is then updated with new potential information for the person.

Question and follow-up user interface 3 is used to make and send an opinion survey to group members to find out the group members' opinions on committing to a set goal. Each member's personal commitment degree is measured using commitment user interface 5, with aid of which a person answers one carefully predetermined opinion alternative. Examples of these opinion alternatives are shown in FIGS. 4 and 5, where the alternatives are shown on the outer circumference of a semicircular scale. In this example the opinion alternatives are numbered with commitment values S, that represent the angle values on the circumference. Each person's commitment value or corresponding other information is saved in database 4 as each person's answer.

Above-mentioned user interfaces 2-5 are, for example, html-pages or corresponding using ASP-technology.

To transform potential into competence a scale in accordance with FIG. 4 has been developed and following its principle analyzer 6 included in the arrangement calculates commitment degree and competence and forms a report in accordance with FIG. 8. The analyzer supports both ASP- and Java-technology and is able to handle html-files.

With the aid of analyzer 6, included in the arrangement, each person's competence K is calculated on the basis of the person's saved potential P and probability T calculated from the saved commitment degree. The commitment degree illustrates the angle ∝, where commitment value S representing a person's opinion, is on a circumference of a semicircular scale. The commitment value is, in this example, given integer values 0 . . . 8, where the value zero represents the opinion “I do not approve” and the value 8 represents the opinion “I am not aware”.

A semicircle, forming the scale of 180°, has been divided in equal parts in such a way that maximum commitment is situated up in the middle, when angle value being the commitment value gets the value 4. When moving to the left to the side of the scale illustrating understanding, the commitment is reduced to zero in accordance with the degree of understanding so, that commitment is zero when the commitment value S is 8. Correspondingly, when moving to the right of the maximum position to the side of the scale illustrating agreement, the commitment is reduced to zero in accordance with the degree of agreement so, that commitment is zero when the commitment value S is 0. The bottom of the scale is a straight line, where a zero point 0 is situated co-linearly with the vertical axis in the middle of the scale.

The scale brings out the dualism of two different matters towards the measured matter to facilitate drawing conclusions. The example illustrates a formulation of questions in accordance with FIG. 4, in which the terms “I am not familiar with” and “I do not entirely approve” have different starting points in relation to the measured matter, but the weighted value of the comparative values represented by the both is the same on the vertical scale. Commitment values 1 and 7 presenting the terms give the same projection to the vertical axis.

A probability calculation is joined to the scale so, that the probability T=1 is up in the middle and on both sides at the bottom of the scale the probability is T=0. Commitment degree is transformed to probability with the aid of commitment value S and the sine expression of the corresponding angle α

$$T = sin ( \frac{π}{8} * {S}_{i} ) = sin ( α ) \qquad \text{(formula 1)}$$

where

T=probability corresponding to the commitment degree

Sᵢ=commitment value, Sᵢ ε (0 . . . 8)

π/8=angle interval of the scale (cf. commitment value)

α=angle of the potential segment of a line (0≦α≦π)

Each person's potential segment of line P is placed on the scale in accordance with the inquiries in the manner presented in FIG. 4. The potential is transformed in to competence with the aid of the formula

K=P*T (formula 2)

where

K=competence

P=measured potential

T=probability corresponding to commitment degree

For example, competence for person A illustrated in FIG. 4 is calculated in accordance with formula 3 as follows

$${K}_{A} = {P}_{A} * sin ( \frac{π}{8} * {S}_{i} ) = 4 * sin ( \frac{π}{8} * 2 ) = 2 , 8 \qquad \text{(formula 3)}$$

Commitment and competence of the entire group is balanced on an understanding-agreement scale in accordance with FIG. 5. In order for the balanced competence to directly indicate the probability of attaining goals, the scale has to be scaled with the number of the group members in accordance with the potential segments of line in the sample in FIGS. 4 and 5. The scaling is done in accordance with formula 4 as follows

R=Nₓ*Iₘₐₓ (formula 4)

where

R=size of the scale shown as units of measurement of the radius

Nₓ=number of group members to be balanced

Iₘₐₓ=chosen maximum value for the index (now chosen to be 5)

Thus, when only one person is measured, the size of the scale R_{A} is in accordance with FIG. 4

R_{A}=1*5=5.

With the procedure of the present invention a probability can be calculated when a) probability is determined by commitment degree based on predetermined scale between 0 . . . 1 and when b) the scale is scaled with the number of segments of line to be presented, when the statistical tree pattern, illustrated in FIG. 6 is realized and in which pattern the sum of probabilities is always 1, thus

T_{attainable}+T_{not attainable}=1 (formula 5)

The measuring of entire group is illustrated in FIG. 5, which presents the distribution of commitment of the group by examining the potential segments of line P_{A}. . . P_{D} representing the persons. Also commitment degree and the probability of attaining a goal through competence are shown. The size of the scale R in FIG. 5 according to formula 4 is

R_{R1}=N_{X}*Iₘₐₓ=4*5=20

Thus the length of the radius R_{R1} of the scale is 20 units.

The mathematical formula for balanced total competence for the entire group is illustrated in formula 6 as follows

$$\begin{matrix}{K}_{R1} = {\sum }_{i = 1}^{{N}_{x}} {P}_{i} * sin ( \frac{π}{8} * {S}_{i} ) = {K}_{R1} = {\sum }_{i = 1}^{4} {P}_{i} * sin ( \frac{π}{8} * {S}_{i} ) \\ 4 * sin ( \frac{π}{8} * 2 ) + 3 * sin ( \frac{π}{8} * 6 ) + 2 , 7 * sin ( \frac{π}{8} * 6 ) + 2 , 7 * sin ( \frac{π}{8} * 7 ) \\ 2 , 8 + 2 , 1 + 1 , 9 + 1 , 0 = 7 , 8\end{matrix} \qquad \text{(formula 6)}$$

The balanced total competence K_{R1} calculated by analyzer 6 is shown graphically on the vertical axis of the scale as a projection of the vector sum of potential segments of line P_{A}. . . P_{D}.

The same matter is illustrated by probability T_{K} calculated from the competence, when the scale has been transformed to percent scale from zero to one hundred. Because both potential and commitment degree influence the competence, the probability of attaining a goal is

$${T}_{K} = \frac{{K}_{R1}}{{S}_{R1}} * 100 \% = \frac{7 , 8}{20} * 100 \% = 39 \% \qquad ( formula 7 )$$

The probability of competence T_{K} is in this case naturally lower than the probability of commitment degree T_{T}, because the persons' potential P is not 100-percent, thus would have got the value 5 with every person.

Probability of balanced commitment degree T_{T} for a goal is

$${T}_{T} = \frac{{K}_{R1}}{\sum {P}_{i}} * 100 \% = \frac{7 , 8}{4 + 3 + 2 , 7 + 2 , 7} * 100 \% = 63 \% . \qquad \text{(formula 8)}$$

Probability of commitment degree T_{T} is not dependent on the potential of the persons of the group. Only commitment to a given goal is measured. If all the persons were committed to 100-percent, all would have commitment value=4, the probability T_{T} would be=100%, or 1. Competence in accordance with maximum commitment degree (100%), in other words sum of potentials is illustrated in FIG. 5 as a small circle on the vertical axis of the scale. Probability for formula 8 is indicated in the relation between T_{K} and the sign representing the sum of the potentials.

As to statistical methods the correspondence is found in statistical tree pattern presented in FIG. 6.

In the foregoing the commitment degree describes the probability for the group directing its resources towards a set goal. The goal is most probably attainable when both potential and commitment degree are as high as possible. Together the potential and the commitment degree form a competence. When total competence K_{R1} is compared to the maximum value of the scale S_{R1} it results in probability T_{K}, with which the goal is attainable.

The management of a company might be interested in the probability for that a responsible group R1, or persons A,B,C and D, can realize a given goal in a given time. Calculated on level 1 this means just the same persons as individuals, when the probability can be calculated with the aid of the formula

T_{L1}=0,5*0,5*(56+42+38+20)=39%

Correspondingly, calculated on level 0 the next, higher level, meaning the product management unit T1 and purchasing unit H is meant. In that case the probability would be

T_{L0}=(1/3*(56+42+38)+20)*0,5=(45,3+20)*0,5=33%

The difference in percentage in calculating essentially the same thing for two different levels is due to that in balancing the competence for level L1 all the parts of the competence have the same weight value. Because group R1 in particular has now been examined it is not worth doing the balancing for level L0. Balancing level L0 would mean that the entire purchasing unit H would have the same weight value as the product management unit T1. When just one person from the purchasing unit, person D, has answered the inquiry, he presents the entire purchasing group.

FIG. 8 illustrates balancing of the group's competence with the arrangement tool in accordance with the invention after committing has been done after a measurement in accordance with FIG. 5. Group R1 has brought to be very committed after the goal SK has been specified and the schedule has been change to be more realistic in the group's opinion. The figure shows also that competence cannot be improved very much with commitment, but by improving potential, or resources, of the entire group.

Arrangement illustrating apparatus shown in FIG. 7 is based on a LAN network, to which the necessary arrangement components, such as a potential user interface 2, question and follow-up interface 3, commitment user interface 5, database 4 and analyzer 6 are connected. Even though the network shown in the example is local network LAN, another suitable network, such as Internet, intranet, wireless telecommunication network or corresponding can also be used. The arrangement is based on the use of a browser when collecting initial information, such as opinions and inquiries and when viewing analysis results. As browser based the arrangement enables administering the competence of the spread out resources via Internet and/or intranet networks also utilizing WAP-technology. The number, purpose and name of interactive user interfaces 2, 3, 5 can vary according to each application.

It is obvious to the person skilled in the art that the invention is not limited to the example described above, but that it may be varied within the scope of the claims presented below. Thus, procedure and arrangement in accordance with the invention are easily adaptable for several different uses, where decision-making can be guided by opinion surveys. Improving the comfort of car seats can be mentioned as an example. A potential of a seat consists of the fact how good it is. Users are asked, for example, their opinion on the comfort of the seat and the price of the seat. A potential of a seat shown on the vertical scale that illustrates, for example, maturity of the purchasing decision is then balanced between comfort and price. In this manner the maturity degree of a purchasing decision is attained, in other words the probability of a customer purchasing the seat.

The basic idea of the invention—a measurement, which is transformed with the aid of a suitable scale into probability-is applicable in the same manner for all product improvement and -development work. FIG. 9 shows an example for applying the invention as a support for decision-making in a state gate-type of a management process. The prerequisite of the decision-making are analyzed by proportioning the economic components of an investment to the risk level and degree of completeness. The dualism of the scale is now on the one hand risks associated with continuing the matter to be decided and on the other hand the degree of completeness. The length of the segments of line P_{IRR} on the scale represents now an internal interest R_{IRR} associated with repayment period, which gets values between 0 . . . 100%. At a zero point 0 at the bottom of the scale the value of the internal interest is 0% and on the circumference at the top of the scale I₁₀₀ the value of the internal interest is 100%. The result of the comparison indicates the maturity degree of decision-making, or whether continuing or its alternative discontinuing or continued processing is a better option. As potential for a decision-making phase of a process can be chosen, for example, an internal interest rate calculated for an investment. Then the competence K_{IRR} obtained as a result of the comparison indicates directly the probable internal interest of the investment. If the internal interest is below the set decision level G_{L} the option is either discontinuing or continued processing. The analysis clarifies the need for continued processing, which can be directed towards minimizing risks, increasing degree of completeness or improving market value. In the example shown in FIG. 9 the grounds for continuing a process are clear even though the degree of completeness stays at 80 %. In a phased product development process a well-timed decision to continue can remarkably shorten the time in which the product reaches the market. If the prerequisites are in order it is not worth waiting for the degree of completeness to reach 100 %.

The solution of the invention can also be used in analyzing different strategic processes in the industry, such as make or buy-analysis or development analysis of a company. On the scale shown in FIG. 10 a company's development investments are analyzed in relation to the company's turnover. The length of the scales radius R_{INV} is chosen to be, for example, 10% of the company's turnover. Then the percentual FIG. 0 is at the center point 0 of the scale and 10% on the circumference of the scale. The dualism of the scale is now the relation between the investment of the development project and the strengthening of the present product strategy. On one hand, qualitatively influencing strategic investments, that the left side of the scale Q_{L} represents, and on the other hand, the quantitively influencing operative investments, that are mainly, for example, product improvements. Operative investments are represented on the right side Q_{M} of the scale. Costs, that are represented on the scale shown in FIG. 10 by the length of the segments of line P_{INV}, are budgeted in analyzing different product development projects P_{INV}. The competence K_{INV} obtained as a result of the analysis indicates the present activity's strengthening degree as, for example, percentage of the turnover on the scale R_{INV}. The analysis provides an idea of whether the emphasis is on changing the present product range or on strengthening it.

The solution of the invention is also applicable with processes, where the process parameters, such as temperatures, pressure, content etc. are measured. These parameters can then be situated on scales formulated for these processes and a probability for a followed event's appearance is attained. By setting alarm boundaries to desired points the course of the events can be interfered when it looks like probability for, for example, failure of a process increases if the process is continued in the same manner.

1. Procedure for controlling and optimizing a process, in which various initial information based on pre-determined criteria is collected, characterized in that, at least two different types of initial information is collected, and that a scale is determined so that a comparison value is created on the basis of the collected initial information is compared with the scale and the process is controlled on the basis of the comparison value to attain a optimized result.

2. Procedure as defined in claim 1, characterized in that, at least two different types of initial information is collected, and a probability (T) for means of achieving a result of the followed process is created based on the collected initial information is created and that the process is controlled on the basis of the created probability to attain an optimized result.

3. Procedure as defined in claim 1 or 2, characterized in that, a segment of line (P), the length of which indicates the initial information's value in relation to a predetermined maximum value (Iₘₐₓ), is formed based on the first collected initial information, and in that, an angle value (S) is created based on the second collected initial information, and in that the segment of line (P) and the angle value (S) are combined so that the formed segment of line (P) is situated on a predetermined equidistant scale forming a 100° angle, to an angle corresponding the angle value (S) so that, the first end of the segment of line (P) is situated at the zero point (O) of the scale.

4. Procedure as defined in claim 1, 2 or 3, characterized in that, the length of the mentioned scale's radius (R) is scaled by multiplying the pre-determined maximum value (Iₘₐₓ) with the number of the segments of line (P) of the sample.

5. Procedure as defined in claim 4, characterized in that, based on the length and on angle value (S) of all the segments of line (P) in the sample, a balanced probability (T_{K}) describing the attaining of a desired result for the mentioned process is formed.

6. Procedure as defined in any of the above claims, characterized in that, the lengths and directions of the segments of line (P) and the balanced probability (T_{K}) describing the attaining of a result are presented graphically so that they are viewable with the aid of user interface (3), WAP-browser or corresponding.

7. Procedure as defined in any of the above claims, characterized in that, a segment of line (P) is formed from, as initial information collected potential representing a person's work ability; and in that an angle value (S) is formed from a commitment value collected as a second initial information and representing a person's commitment degree, which are combined and the created personal probability is balanced taking the entire sample in consideration so that, a balanced probability (T_{K}) for means to attain set goal is attained as a result, and in that the collecting of the initial information and the forming of the balanced probability (T_{K}) are done continuously.

8. Arrangement for controlling and optimizing a process, which arrangement is adjusted to collect various, on pre-determined criteria based initial information, and which arrangement has a user interface (2, 3, 5) to collect initial information and database means (4) to save the collected initial information characterized in that, the arrangement includes a equidistant scale and calculating means, such as analyzer (6), which is adapted to place segments of line (P) corresponding to saved initial information on the mentioned scale on an angle corresponding to the saved angle values (S), and in that the analyzer is adapted to calculate a probability (T) with which the result of a process is attainable.

9. Arrangement as defined in claim 8, characterized in that, the arrangement has means, such as, question and follow-up user interface (3) or corresponding to graphically represent the lengths and directions of the segments of line (P) and the balanced probability (T_{K}) describing attaining a result.

10. Arrangement as defined in claim 8 or 9, characterized in that, the arrangement has means to represent the lengths and directions of the segments of line (P) and the balanced probability (T_{K}) describing attaining a result with the aid of a WAP-browser or corresponding.
